(19) United States
(12) Patent Application Publication
(10) Pub. No.: US 2011/0045698 A1
(43) Pub. Date: Feb. 24, 2011

(54) EMI connector filter assembly

(76) Inventor: Mark A. Kelly, Endicott, NY (US)

Correspondence Address: Daniel P. Labzentis, 628 McFadden Road, Apalachin, NY, 13732, US

(21) Appl. No.: 12/587,733

(22) Filed: Oct. 13, 2009

Related U.S. Application Data
(60) Provisional application No. 61/195,810, filed on Oct. 10, 2008.

(51) Int. Cl. H01R 13/648

(52) U.S. Cl. 439/607.01

(57) ABSTRACT

A connector and cable assembly is disclosed that provides a means to protect another piece of electronic hardware in a system from disruptions due to electromagnetic interference by introducing an appropriate filtering element to the connector filter assembly, external to the affected electronic hardware, eliminating the need to redesign the hardware. The assembly can also accommodate a circuit breaker in one embodiment of the invention.

### FIELD OF THE INVENTION

The present invention relates to a connector assembly that incorporates the capability to provide filtering of electromagnetic interference, thereby protecting the signal integrity of the electronics to which the assembly is connected.

### BACKGROUND OF THE INVENTION

Modern electronic devices can be susceptible to electromagnetic interference (EMI). For such devices, care must be taken to prevent EMI from entering the device in sufficient magnitude to alter the operation of the electronics. Typically this is accomplished by filtering out the EMI at any conductors that could otherwise allow it into the device.

Electrical connectors having integral filter assemblies for attenuation of electrical interference are finding an increasing demand in the communication, data handling and aerospace industries. To meet this demand a wide variety of filter connector assemblies have been developed which utilized tubular ceramic capacitors, ferrite inductance ferrules and conductive elastomers of rubber or plastic. Another method that has been employed is to populate a flexible circuit with capacitors for the purpose of filtering signals just before they enter the device. These methods are used singly or in combination as a means of attenuating the transmission of undesired electromagnetic interference (EMI) through conductors terminated to the connectors by providing a low impedance path to ground for EMI. These filter assemblies also reduce EM radiation from a closed connector and lessen the susceptibility of a closed connector to pickup of externally generated EMI.

It is not unusual to discover issues with EMI after an electronic device has been designed and built. Redesigning an electronic device to address such a discovery can be time consuming and costly, therefore a method to address EMI external to an affected electronic device would be beneficial.

### DISCUSSION OF RELATED ART

As example, U.S. Pat. No. 6,781,481 to Patrick for METHODS AND APPARATUS FOR FILTING ELECTROMAGNETIC INTERFERENCE FROM A SIGNAL IN AN INPUT/OUTPUT PORT describes a filtering apparatus for specific application to an input/output port. The present invention is not limited in application to an input/output port.

U.S. Pat. No. 5,680,297 to Noah et al. for CONNECTOR INTERFACE INCLUDING EMI FILTERING discloses EMI filtering on a computer panel housing to provide filtering just prior to transmitting signals. This patent does not provide the ability to filter a signal from outside the electronic equipment, which in this case is the computer.

U.S. Pat. No. 5,416,673 to Kenji et al. for MOUNTING STRUCTURE FOR EMI PREVENTION FILTER describes a structure that differs substantially from the present invention. For example, it does not provide for filtering of high power circuits, or for the need to filter multiple conductors within a structure with unique filtering requirements.

Also, U.S. Pat. No. 6,888,715 to Stevenson et al. for EMI FEEDTHROUGH FILTER TERMINAL ASSEMBLY UTILIZING HERMETIC SEAL FOR ELECTRICAL ATTACHMENT BETWEEN LEAD WIRES AND CAPACITOR describes a feedthrough with built-in EMI filtering capability. This patent suffers from the disadvantage that it cannot be design to filter high power signals, and it is not useful to address the situation when EMI filtering needs to be added to an electronic system after the design has been completed.

### SUMMARY OF THE INVENTION

It is an object of the present invention to provide an EMI connector filter assembly that that will effectively filter EMI outside of the electronic device, preventing the need to redesign or alter the electronic device itself, and allowing for a rapid solution to an EMI issue.

It is a further object of the present invention to provide capability to filter high power and high current signals. Methods to deal with high power signals can be bulky, and therefore difficult to handle with typically employed methods.

It is a further object of the present invention to provide a means to quickly provide an interim EMI solution for an electronic device for either testing/validation or interim use until design changes can be implemented within the device.

It also an objective of the present invention to provide a method to enable the building of said EMI connector filter assemblies.

### BRIEF DESCRIPTION OF THE DRAWINGS

FIG. 1 is a depiction of an EMI connector filter assembly illustrating an embodiment of the EMI filtering technique for one of the multiplicity of conductors attached to a connector.

FIG. 2 is a depiction of an EMI connector filter assembly illustrating another embodiment wherein an EMI filter pin and a circuit breaker are included in the assembly, encased by a Y-shaped, shielded enclosure.

### DETAILED DESCRIPTION OF THE PREFERRED EMBODIMENT

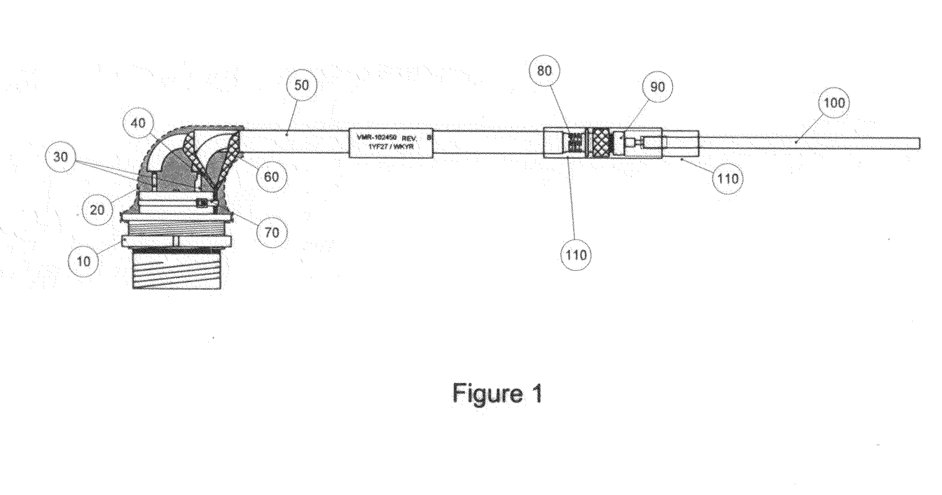

FIG. 1 illustrates one mode of the disclosed invention. One end of the flexible EMI connector filter assembly has a connector 10 with a conductive backshell 20. Said connector contains a multiplicity of conductive pins 30. The center conductor 40 of shielded cables 50 or conductor are attached to some or all of said pins via soldering or other means. One or more shield layers 60 are attached via soldering, mechanical retention 70, or other means, to the body of the connector 10, which is electrically at a ground or common voltage level.

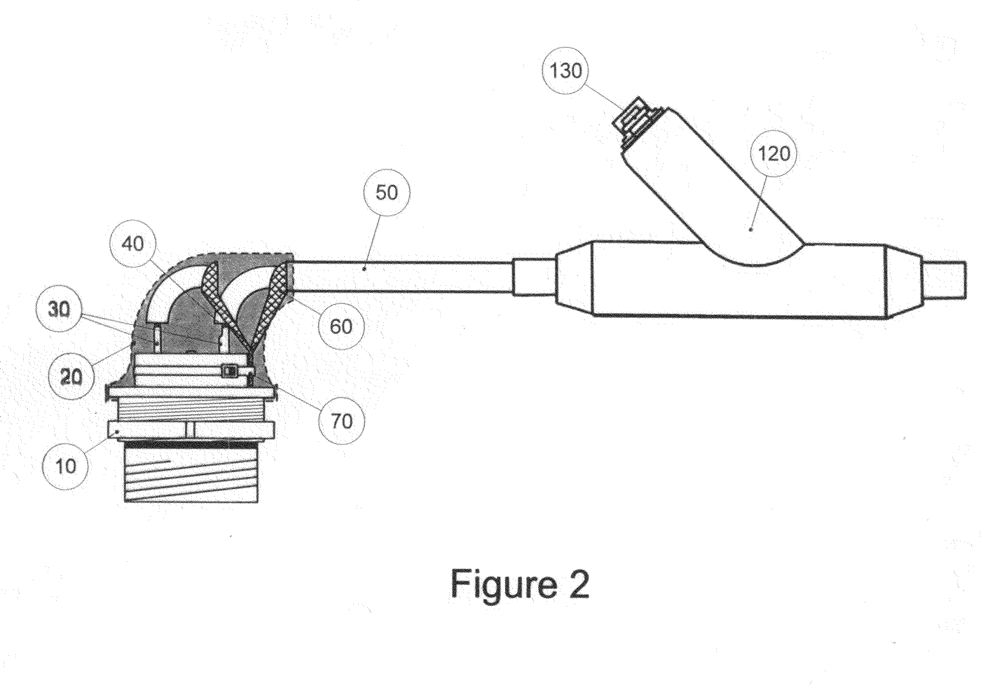

At a convenient distance away from the connector, said shielded cables or conductors are terminated to a banding adapter 80. For the multiplicity of circuits, said banding adapter may be located at varying distances from said connector as required. It is not necessary to place said banding adapters at an equal distance from said connector. FIG. 2 illustrates another embodiment of the invention, which makes use of a Y-shaped backshell 120 to accommodate an EMI filter and circuit breaker 130. Convenient distance can be defined by the amount of flexibility required in the particular application of the desired flexible EMI connector filter assembly, or by other physical constraints of the application. The banding adapter or other suitable termination is able to accommodate, by threaded or other means, an EMI filter 90, which is suitably attached to the center conductor of the shielded cable. The other end of the EMI filter is attached to a different shielded cable 100, which continues on to its destination. The EMI filter 90, banding adapter 80, and termination to said different shielded cable 100 may be electrically and mechanically protected by means of a non-conductive tape or shrink tube 110 or other means. The destination at the other end of the second shielded cable is not important to this invention, but it is important to note that this second cable, or any hardware that it is connected to, could produce an undesirable signal or response to electromagnetic interference. The filter pin acts to prevent EMI signals from entering the first shielded cable and connector assembly, thereby protecting the electronics that the connector is suitable attached to.

There are many uses for this invention. The response of sophisticated electronic equipment or systems to EMI is difficult to predict, and therefore EMI issues are often encountered on a trail and error basis, particularly during development. It is typical in the industry to build electronics equipment to the requirements and standards that are known at the time, test the equipment for susceptibility to EMI, and make design changes to the electronics equipment as necessary to address any problems that are discovered. These design changes may involve altering the design of a circuit card or adding additional components inside the equipment, or adding a completely new circuit card or connector. Often, the design changes have to be evaluated on a trial and error basis by implementing a change that may address the EMI issue, and re-testing the equipment to determine if the design change was effective. This approach is costly in terms of the iterative design changes (and re-test trials) and in terms of the time lost.

The disclosed invention provides a way to provide supplemental EMI filtering external to the electronics equipment under test, which can be used to help determine which circuits contribute to EMI responses, and to help determine which type or value of filter pin is most effective in preventing EMI responses. The disclosed invention could also provide sufficient EMI protection to prohibit any need for further design changes to the electronics equipment under test. Also, some circuits in electronic hardware are required to carry significantly more power than other circuits. Proper EMI filters for these circuits may become too bulky to accommodate within a filtered connector. The disclosed invention provides a means to accommodate EMI filtering of such circuit external to the connector body.

The present invention features a novel method to provide EMI filtering for electronic equipment. The method includes the steps of removing the outer insulation jacket from a multiplicity of shielded or coax cable 50 for a convenient length, and slitting the braid shielding without removing it from the cable, providing sufficient length such that it the braided shield 60 can be electrically attached to said connector body 10. The method includes the steps of soldering the center conductor of a multiplicity of shielded or coax cable 50 to connector pins 30 using soldering methods known in the industry. One embodiment makes use of solder sleeves. Another step includes attaching all of the multiplicity of said braided shield to said connector body by employing soldering or mechanical or other means. Mechanical means may include attachment using a flexible metal band 70. Another step includes the addition of a conductive backshell 20 to the connector body 10. Yet another step includes the attachment of a banding adapter 80 or a conductive backshell to the opposite end of the multiplicity of the shielded or coax cables 50. Generally, the purpose of the banding adapter or backshell is to accommodate the addition of an EMI filter. Another step includes providing the center conductor of said shielded or coax cable 50 through said banding adapter 80 for attachment to EMI filter 90. Said EMI filter 90 is attached to said banding adapter or backshell via threaded or other means. Another step includes attaching the shield of said shielded or coax cable 50 to the banding adapter 80 via means of soldering, a flexible metal band, or other means. Yet another step includes attaching a said second shielded or coax cable 100 to said EMI filter via soldering or other means. The banding adapter 80, EMI filter 90, and shielded or coax cables 80 and 100 may all be protected by the additional step of overlaying these devices with shrink tube 110.

What is claimed is:

1. An EMI connector filter assembly that provides for electromagnetic interference filtering of a conductor or plurality of conductors external to affected electronic apparatus, comprising:
a connector having one or more connector pins;
a conductive backshell;
a shielded conductor or plurality of shielded conductors;
an electromagnetic interference filter;
a means to terminate said shielded conductors to said electromagnetic filter; and
a means to electrically connect said electromagnetic interference filter to a further shielded cable.

2. The EMI connector filter assembly of claim 1 wherein the shield layers of said plurality of shielded conductors is electrically connected to said connector shell by means of soldering or by means of mechanical retention.

3. The EMI connector filter assembly of claim 2 wherein the mechanical retention is by means of a metal band.

4. The EMI connector filter assembly of claim 2 wherein the center conductor of said plurality of shielded conductors is electrically connected to said connector pins.

5. The EMI connector filter assembly of claim 4 wherein said plurality of shielded conductors is electrically connected to said connector pins using solder sleeves.

6. The EMI connector filter assembly of claim 1 wherein the means to terminate said shielded conductors to said electromagnetic filter is with the use of a threaded banding adapter.

7. The EMI connector filter assembly of claim 6 wherein the said electromagnetic filter is a filter pin that mates with the threads of said banding adapter.

8. The EMI connector filter assembly of claim 7 wherein said filter pin is connected by means of soldering to said further shielded cable.

9. The EMI connector filter assembly of claim 8 wherein said banding adapter, said filter pin, and electrical connections to said shielded conductor and said further shielded cable are electrically and mechanically protected with non-conductive tape or shrink tube.

10. The EMI connector filter assembly of claim 9 wherein the EMI connector filter assembly includes a Y-shaped backshell housing said filter pin and a circuit breaker.
